(19) United States
(12) Patent Application Publication
(10) Pub. No.: US 2020/0304570 A1
(43) Pub. Date: Sep. 24, 2020

(54) Event-Based Self-Stabilizing Feedback Controller for Geographically Distributed Systems

(71) Applicant: Conversant LLC, Chicago, IL (US)

(72) Inventors: Zhihao Lou, Chicago, IL (US); Lifeng Jia, Northbrook, IL (US); Michael North, Chicago, IL (US); Steve Nowlan, Chicago, IL (US)

(73) Assignee: Conversant LLC, Chicago, IL (US)

(21) Appl. No.: 16/360,839

(22) Filed: Mar. 21, 2019

(51) Int. Cl. H04L 29/08; G06Q 30/02

(52) U.S. Cl. CPC H04L 67/1095; G06Q 30/0275; G06Q 30/0277

(57) ABSTRACT

A system of synchronized computing devices, connected via a common network and configured to operate one or more common computing tasks across the system, includes a plurality of subcomponent computing devices, each including, at least, a non-transitory, machine readable storage medium, storing instructions associated with the one or more common computing tasks. The system further includes one or more processors, each of the processors configured to output a plurality of events occurring throughout the system. The system further includes a synchronization controller configured to determine a continually updating value of interest, based on a symmetric function of the one or more events, provide the continually updating value of interest, subject to a time delay, wherein the time delay is a time period having a length substantially longer than an average time interval between two consecutive members of the plurality of events.

### TECHNICAL FIELD

The present disclosure relates generally to massively and geographically distributed systems and, more particularly, to systems and methods for establishing a self-stabilizing feedback controller for such massively and geographically distributed systems.

### BACKGROUND

Distributed computing systems are computational systems that include a plurality of computing components that are located in different geographical locations, be they relatively local or trans-national, which coordinate for the purposes of a common task or action, by passing messages to one another. Such distributed systems are commonly used in a variety of industries for a variety of tasks, such as service-oriented architecture (SOA) based systems, online gaming software and systems, and digital advertising platform components, among other things.

Many systems utilize feedback controllers to allow the systems to react to changing environments associated with a task, while maintaining internal states and/or system outputs, within desired ranges. Such feedback controllers may be implemented as software elements, hardware elements, or a combination of the two and are based on direct or indirect measurements of the internal states of the given system. In some example, large scale, distributed systems, the state can change across different subcomponents much faster than it can bet synchronized, due to delays inherent in synchronization. This may be of particular concern in non-homogenous, massively distributed systems where internal states, in different parts of the system, are frequently operating in very different regimes and the distribution of state is very non-regular.

However, the use of feedback controllers in distributed systems is rare, as synchronization issues may arise. For many distributed systems, the delay in synchronizing state variables over many different subcomponents can prevent standard feedback controllers from operating at optimal efficiency. In such scenarios, system architects may be forced to chose between systems that are stable, but slow to respond (e.g., a system that updates no more frequently than the minimum synchronization interval) versus a fast-reacting solution, which may potentially become unstable.

Prior attempts to solve the stability versus speed conundrum have resulted in solutions that limit the state update frequency to the minimum synchronization speed. Such controllers can always update based on consistent information, thus remaining stable; however, doing so limits the speed at which the system can react to its environment. Alternatively, some controllers allow the state to be updated faster than the synchronization speed, by using fixed control parameter, yet, this controller is prone to instability, due to a delay in the feedback of control changes.

Accordingly, a distributed system feed back controller that allows a control variable to be updated as frequently as the underlying state variable updates events, while still maintaining stability, is desired.

### SUMMARY

In accordance with an embodiment, a system of synchronized computing devices, connected via a common network and configured to operate one or more common computing tasks across the system, is disclosed. The system includes a plurality of subcomponent computing devices, each including, at least, a non-transitory, machine readable storage medium, each of the storage media of the plurality of subcomponent computing devices storing instructions associated with the one or more common computing tasks. The system further includes one or more processors, each of the one or more processors associated with one or more of the plurality of storage media, each of the one or more processors configured to execute instructions which, when executed, at least, output a plurality of events occurring within the context of the one or more computing tasks throughout the system. The system further includes at least one synchronization controller, operatively associated with one or more of the plurality of subcomponent computing devices, configured to receive the plurality of events from the one or more processors, to determine a continually updating state variable and a continually updating sum of error terms based on a symmetric function of the one or more events, provide the continually updating value of interest, subject to a time delay, wherein the time delay is a time period having a length substantially longer than an average time interval between two consecutive members of the plurality of events.

In accordance with another embodiment, a method for synchronizing a plurality of computing device is disclosed. Each of the plurality of computing devices is connected via a common network and configured to operate one or more common computing tasks, amongst the plurality of computing devices. The one or more computing tasks includes, at least, a plurality of events. The method includes outputting, using a processor of at least one of the plurality of computing devices, the plurality of events to at least one synchronization controller. The method further includes determining, using a processor associated with the at least one synchronization controller, a continually updating value of interest, based on a symmetric function of the plurality of events. The method further includes providing, using the processor associated with the at least one synchronization controller, the continually updating value of interest, subject to a time delay, wherein the time delay is a time period having a length substantially longer than an average time interval between two consecutive members of the plurality of events.

In accordance with yet another embodiment, a system for serving online advertisements to a subject to online advertisement is disclosed. The system includes a plurality of synchronized computing devices connected via a common network and configured to operate one or more common advertising data operations across the system. Each of the subcomponent computing devices includes, at least, a non-transitory, machine readable storage medium and each of the storage media of the plurality of subcomponent computing devices stores instructions associated with the one or more common advertising data operations. The system further includes one or more processors, each of the one or more processors associated with one or more of the plurality of storage media and each of the one or more processors being configured to execute instructions, which, when executed, at least, output a plurality of events, occurring within the context of the one or more common advertising data operations throughout the system. The system further includes at least one synchronization controller, operatively associated with one or more of the plurality of subcomponent computing devices, configured to receive the plurality of events from the one or more processors, to determine a continually updating value of interest, based on a symmetric function of the one or more events and provide the continually updating value of interest, subject to a time delay L. L is a time period having a length substantially longer than an average time interval between two consecutive members of the plurality of events.

### BRIEF DESCRIPTION OF THE DRAWINGS

FIG. 1 is a diagram exemplary of an environment in which the systems and methods disclosed herein may be utilized, in accordance with an embodiment of the disclosure.

FIG. 2 is a process flow diagram for a process, in which the systems and methods disclosed herein may be utilized for process synchronization, in accordance with an embodiment of the disclosure.

FIG. 3 is a block diagram of elements of the systems and methods of the disclosure, illustrating functionality overlaid upon computing elements, in accordance with an embodiment of the disclosure.

FIG. 4 is an alternative block diagram of the elements of the systems and methods of the disclosure, illustrating functionality overlaid upon computing elements, in accordance with FIG. 3 and an embodiment of the disclosure.

FIG. 5 is another alternative block diagram of the elements of the systems and methods of the disclosure, illustrating functionality overlaid upon computing elements, in accordance with FIGS. 3-4 and an embodiment of the disclosure.

FIG. 6 is a block diagram illustrative of functionality of a synchronization system of the systems and methods described with reference to FIGS. 1-5.

FIG. 7 is another block diagram illustrative of functionality of the synchronization system of the systems and methods disclosed herein, in accordance with FIGS. 1-6 and the present disclosure.

FIG. 8 is a block diagram illustrative of a system for serving online advertisements while utilizing the computing network and synchronization system disclosed with reference to FIGS. 1-7, in accordance with another embodiment of the disclosure.

FIG. 9 is a block diagram of an exemplary computing device capable of embodying one or more elements of FIGS. 1-8.

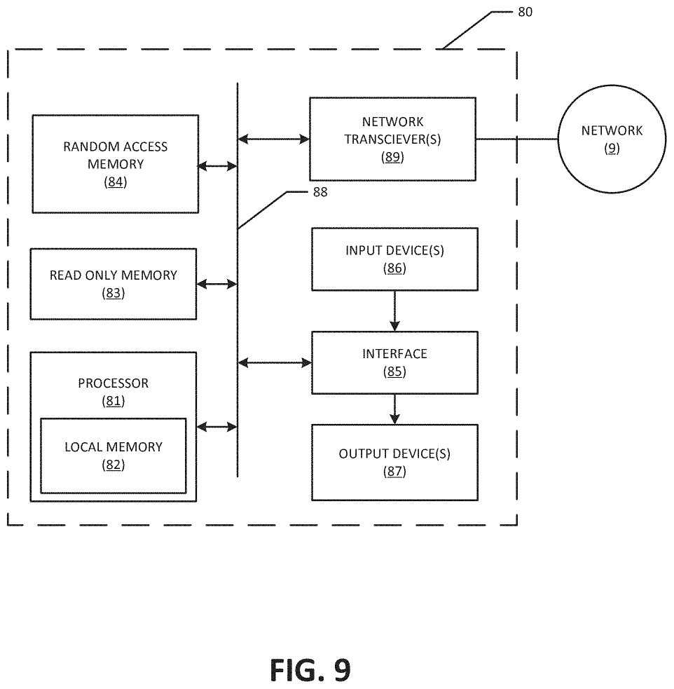

While the present disclosure is susceptible to various modifications and alternative constructions, certain illustrative examples thereof will be shown and described below in detail. The disclosure is not limited to the specific examples disclosed, but instead includes all modifications, alternative constructions, and equivalents thereof.

### DETAILED DESCRIPTION

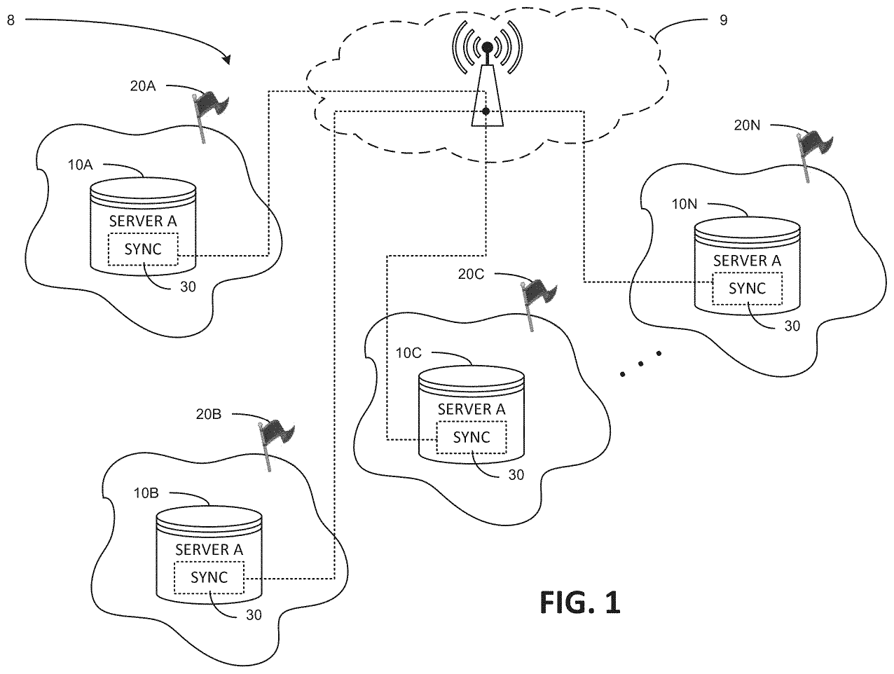

Turning now to the drawings and with specific reference to FIG. 1, a system 8 of synchronized computing devices 10 are illustrated. Each of the computing devices 10 is connected to one another via a network 9, which may be any network configured to connect the plurality of computing devices 10 (e.g., the Internet). As depicted, each of the plurality of computing devices 10, which may be considered “subcomponents” of the system 8, are located at a different geographic location 20. One or more computing devices 10 may be located at each geographic location 20. The geographic locations 20 may be anywhere on Earth, or potentially beyond, wherein the computing device 10 is capable of connection to the other computing device(s) 10 via the network 9. The geographic locations 20 may be widely spread (e.g., transnationally, transcontinentally, etc.) and/or the geographic locations 20 may be relatively local (e.g., citywide, sitewide, statewide, nationwide, etc.).

As depicted, there may be any number (“n” number) of computing device(s) 10A-N, so long as each of the computing devices 10 are connected to one another and function as part of the massively, geographically distributed system 8, to operate one or more common computing tasks across the system 8. As described in the introduction, such distributed systems may be utilized to perform any number of computing tasks across such a plurality of computing device(s) 10, such as, but certainly not limited to, service-oriented architecture (SOA) based systems, online gaming software and systems, and digital advertising platform components, among other things.

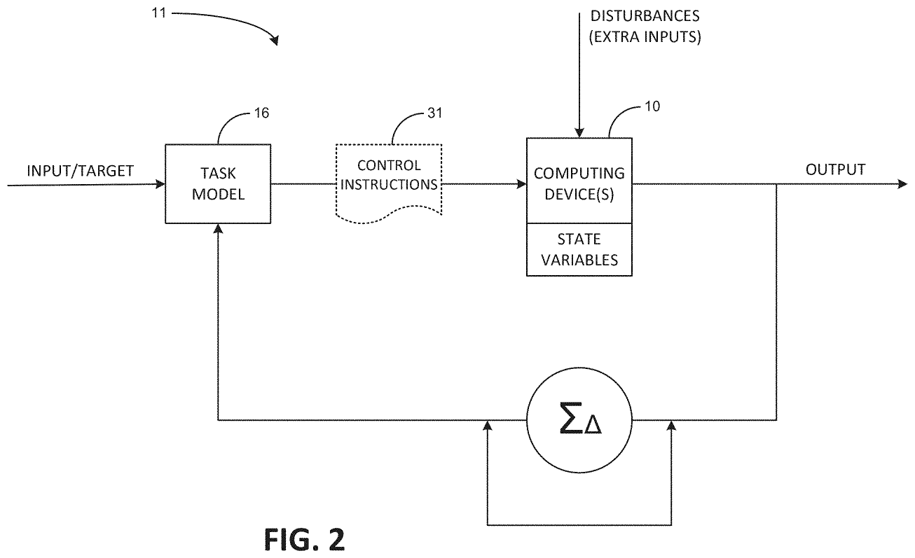

Referring now to FIG. 2, a process diagram 11 is depicted which illustrates how a task model 16 and control instructions 31 influence the computing devices 10. An input or target is input to the task model 16 to determine desired output for the computing task executed by the computing device(s) 10. The input to the computing device(s) 10 is further affected by control instructions 31, which may be determined as part of a synchronization system 30, which is discussed in more detail below. The computing device(s) 10 may further be influenced by disturbances or extra inputs. The state variables of the computing device(s) 10 are output along with a continually updating sum of error terms (ΣΔ). Output is then provided and optimized via synchronization provided by the synchronization system 30.

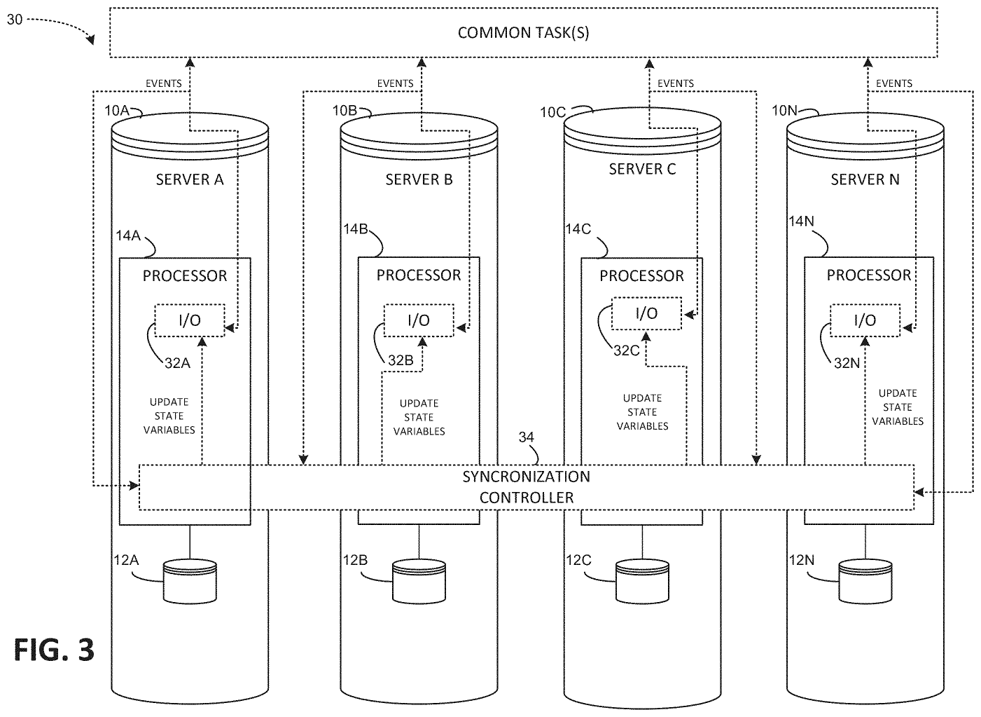

As shown in better detail in FIG. 3, each of the computing devices 10 includes, at least, a non-tangible, machine-readable memory 12, which stores instructions which may be executed by a processor 14 that is included with or associated with each of the computing devices 10. Such instructions may be associated with the one or more computing tasks of the distributed system 8.

One or more of the processors 14 are configured to execute instructions for a synchronization system 30 of the distributed system 10. The synchronization system 30 includes input/output elements 32 at each of the computing devices 10 and a synchronization controller 34, which may be located proximate to and/or may be executed by at least one of the one or more of the processors 14. Accordingly, in some examples the synchronization controller 34 is executed as instructions on each of the one or more processors 14, wherein each of the one or more processors 14 are in continuous operative communication, amongst themselves via the network 9, as depicted in FIGS. 3-5. Additionally or alternatively, in some examples, the synchronization controller 34 comprises one or more controller processing elements physically embodied at the computing device 10 and/or the processor 14, wherein each of such processing elements are configured to perform functions of the synchronization controller 34.

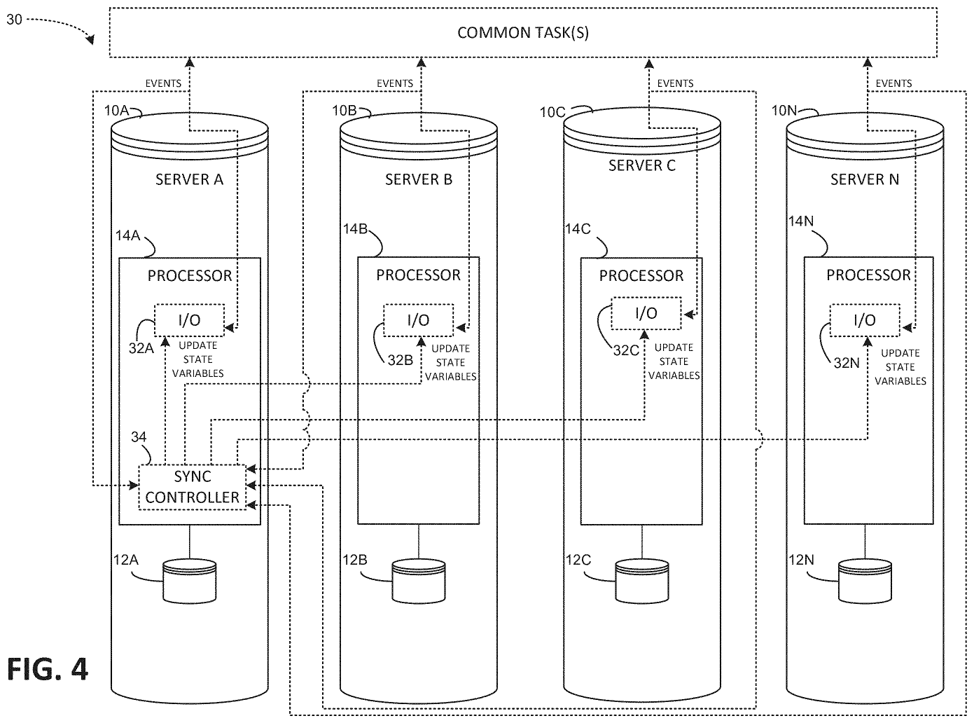

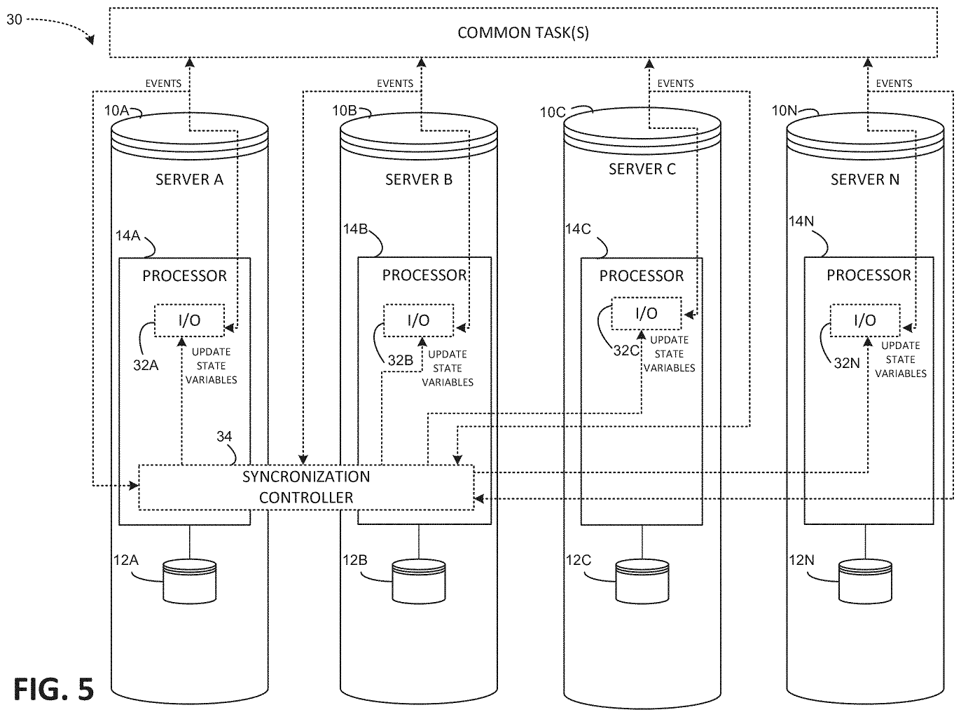

Further, as best depicted in FIG. 4 (which retains common elements to those of FIG. 3), in some alternative examples, function and/or embodiment of the synchronization could be limited to a single processor 14A at a single computing device 10A, while remaining in continuous operative communication with each of the input/output elements 32 of all processors 14 of the computing devices 10. In yet another alternative example illustrated in FIG. 5 (which retains common elements to those of FIGS. 3 and 4), the synchronization controller 34 may be distributed over two or more of the computing device(s) 10, which, as depicted, shows the synchronization controller 34 distributed amongst the processors 14A, 14B of computing devices 10A, 10B, while maintaining continuous operative communication with all input/output elements 32 at all processors 14. However, the choice of distributing the synchronization controller 34 to processors 14A, 14B is merely exemplary and distribution of the synchronization controller 34 may be amongst any processors 14 of the computing devices 10 of the system 8.

The input/output elements 32 are configured to, at least, output a plurality of events occurring within the context of the one or more common computing tasks, throughout the system 8. Within the context of the distributed system 8, each of the computing devices 10 generates such events, which contribute to the change of an internal state of the system 8. Accordingly, such an internal state may be a variable that is expressed as a symmetric function, which is a function that is invariant under the reordering of its variables. In other words, the order of events that are processed by the system 8 does not change the final results and/or final consistent state of the broader system 8; rather, only the processed events are considered. Common examples of symmetric functions include, but are certainly not limited to, counts, means, variances, medians, percentiles, maximums, and minimums.

The synchronization controller 34, distributed amongst one or more of the computing devices 10, is a synchronization mechanism that calculates a running, continually updating, value of a symmetric function of the events associated with the common computing task. As such, the synchronization controller 34 is configured to determine a continually updating value of interest, based on a symmetric function of the events associated with the computing task. Further, the synchronization controller 34 is configured to provide the continually updating value of interest back to each of the computing devices 10 of the system 8, wherein the value of interest is subject to a time delay L, wherein L is a time period having a length substantially longer than an average time interval between two consecutive members of the plurality of events.

In some examples, the synchronization controller 34 may be a proportional-integral-derivative controller (PID controller), which is a control loop feedback mechanism for computing tasks that require continuously modulated control. A PID controller continuously calculates an error value (Δₜ) for each computing device 10 which is calculated as a scaled difference between a desired target value (R) and a measured state variable (Uₜ), scaled by a correction based on proportional, integral, and derivative terms. Accordingly, as a PID controller, the synchronization controller 34 is configured to maintain a state variable U for each of the subcomponent computing devices 10, an events frequency factor T, and an integral term ΣΔ.

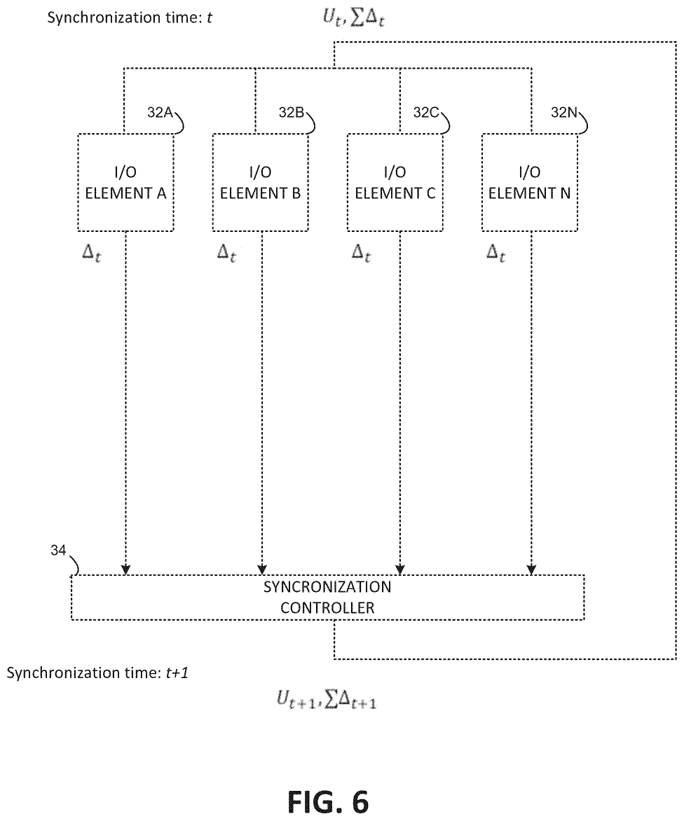

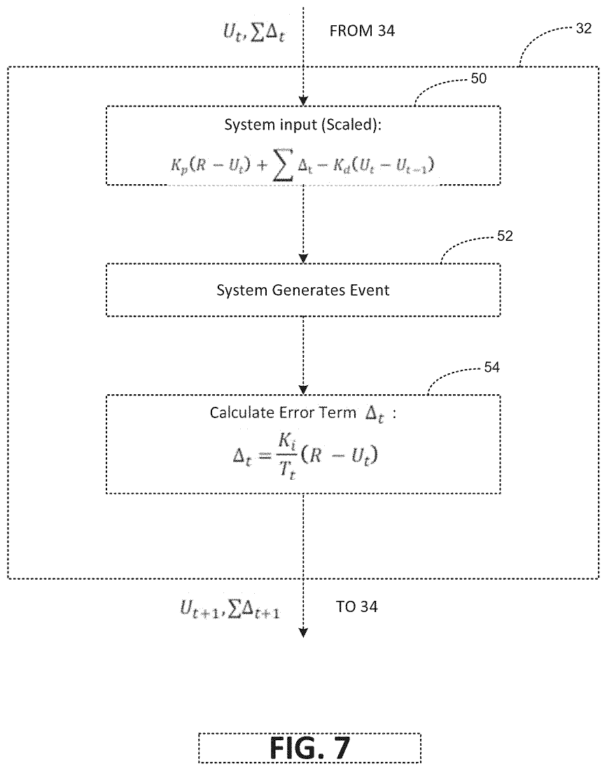

To control the state value U, the synchronization controller 34 maintains, in addition to U, an events frequency factor T and the integral term ΣΔ. Both U and ΣΔ are symmetric functions of the data from the events of the common computing task. As best illustrated in FIGS. 6 and 7, showing the interplay between elements of the synchronization system 30, for each subcomponent at synchronization time t, the system input (provided by the synchronization controller 34 to each of the computing devices 10), is

Kₚ(R−Uₜ)+ΣΔₜ−K_{d}(Uₜ−Uₜ₋₁)

where Kₚ is the proportional gain, K_{d} is the derivate gain, Uₜ is the latest state variable value received from the synchronization, Uₜ₋₁ is the previous value received from the synchronization controller 34, and R is the reference value or the target value that may change over time at a much slower pace than the synchronization of event results. The events frequency factor T may be an estimation of how many events, over a given period of time, are expected within the context of the computing task(s). Kₚ may be how much a factor is weighted in the equation, whereas K_{d} is an estimated change in error. Both Kₚ and K_{d} may be tuned to the system 8, either by manual tuning or by a simulated or estimated value.

As best depicted in the more detailed description of functions of an input/output element 32 in FIG. 7, each input/output element 32 at each computing device 10 receives a prior discrete time (t−1) state U from the synchronization controller 34, which is scaled (as discussed above), illustrated at block 50 of FIG. 7. Then, one or more of the computing device(s) 10 generates an event of the computing task (block 52). As an event has occurred, the input/output element 32 calculates error term

$${Δ}_{t} = \frac{{K}_{i}}{{T}_{t}} ( R - {U}_{t} )$$

which is the difference between target R and the last measurement Uₜ, weighted by system integral gain Kᵢ and the frequency factor Tₜ. The error term is only sent to the synchronization controller 34 and does not update the local value of the integral term. The computing device 10, then, continues to operate at the existing input level (Uₜ₋₁) despite the new event being generated, until the synchronization controller 34 sends back a consistent set of values for Uₜ, Tₜ, and ΣΔₜ.

To achieve actual, self-stabilizing control, the frequency factor Tₜ is updated to approximate the mean number of event updates expected between the successive measurement update intervals of length L, which is the time period having a length substantially longer than an average time interval between two consecutive members of the plurality of events. Accordingly, Tₜ can be calculated by a variety of methods, including, but not limited to: using an external input representing the expected event count over L; using an approximate count of past events over a certain window size (can be performed on a trailing basis to avoid a recursive synchronization problem); and using an estimate based on one of the current state variables (e.g., a function of Uₜ or a multiple of the current count as a function of the time of day).

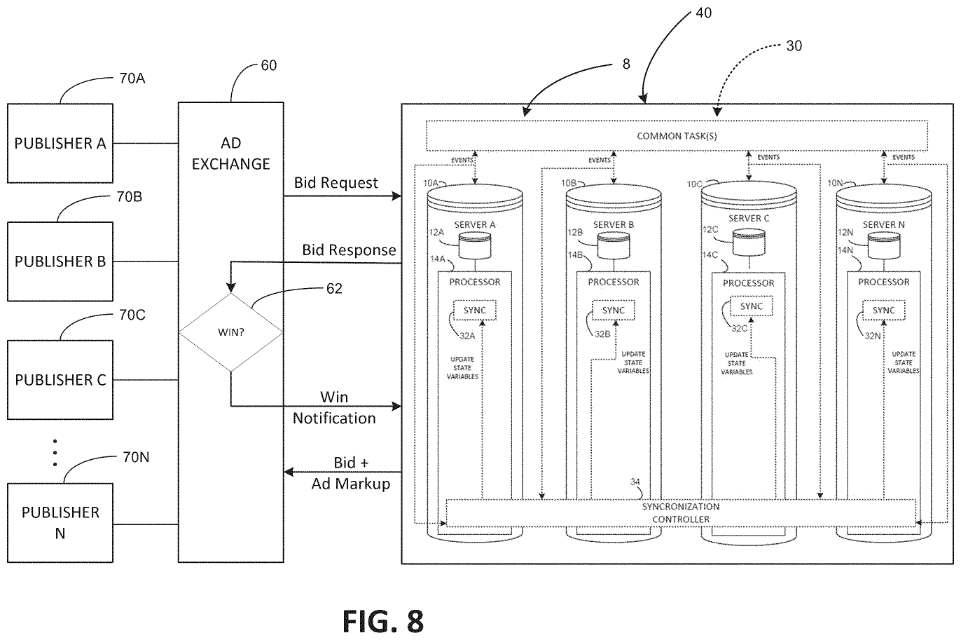

Turning now to FIG. 8, but with continued reference to FIGS. 1-7, an exemplary use of the system 8, including the synchronization system 30, as part of an ad server 40 in the context of digital advertising to a subject to digital advertising, is shown. In such examples, the common computing task is one or more common advertising data operations spread out across the computing devices 10. In the present example, the events are auction “wins” at the ad exchange 60, and the bid price is the input calculated at the synchronization controller 34. In alternative examples, common advertising data operations may include, but are not limited to including, bid pricing on ads, ad spend for a client, resource management, subject data profiling, subject data updating, among other things. Accordingly, such advertising data operations may include frequent updates and, thus, synchronization of individual computing devices 10 of the ad server 40, via the synchronization system 30, may be necessary.

For example, the data operation may be bid pricing and/or associated client ad spend with such bid pricing for serving an online ad to the subject. In such examples, the plurality of events may be a plurality of changes in bid price for serving the advertisement to the subject to online advertising. Further, in such examples, the value of interest may be a bid price to be submitted, via at least one of the one or more processors, to an advertising exchange 60. The bid price may then be submitted to the ad exchange 60, upon request, over the network 9 via one or more transceivers. If the bid price is determined by the advertising exchange 60 to be a “win” or selected bid (decision 62), then a win notification is transferred to the ad exchange 40, and an ad is served with the bid to the ad exchange, for publication at one or more publishers 70A-N.

A combination of hardware and software may be used to implement instructions in association with any of the computing devices 10. FIG. 6 is a block diagram of an example computer 80 capable of executing instructions to realize the functions of any the computing device 14, the site server 20, the consent server 30, and/or the vendor server(s) 40. The computer 80 may be, for example, a server, a personal computer, or any other type of computing device. The computer 80 of the instant example includes a processor 81. For example, the processor 81 may be implemented by one or more microprocessors or controllers from any desired family or manufacturer.

The processor 81 includes a local memory 82 and is in communication with a main memory including a read only memory 83 and a random-access memory 84 via a bus 88. The random-access memory 84 may be implemented by Synchronous Dynamic Random Access Memory (SDRAM), Dynamic Random Access Memory (DRAM), RAIVIBUS Dynamic Random Access Memory (RDRAM) and/or any other type of random access memory device. The read only memory 83 may be implemented by a hard drive, flash memory and/or any other desired type of memory device.

The computer 80 may also include an interface circuit 85. The interface circuit 85 may be implemented by any type of interface standard, such as, for example, an Ethernet interface, a universal serial bus (USB), and/or a PCI express interface. One or more input devices 86 are connected to the interface circuit 85. The input device(s) 86 permit a user to enter data and commands into the processor 81. The input device(s) 86 can be implemented by, for example, a keyboard, a mouse, a touchscreen, a track-pad, a trackball, and/or a voice recognition system. For example, the input device(s) 86 may include any wired or wireless device for connecting the computer 80 to the positioning system 88 to receive positioning signals.

One or more output devices 87 are also connected to the interface circuit 85. The output devices 87 can be implemented by, for example, display devices for associated data (e.g., a liquid crystal display, a cathode ray tube display (CRT), etc.). While depicted, it is certainly possible that an exemplary computer 80 may include no output device(s) 87.

Further, the computer 80 may include one or more network transceivers 89 for connecting to the network 12, such as the Internet, a WLAN, a LAN, a personal network, or any other network for connecting the computer 80 to one or more other computers or network capable devices.

As mentioned above the computer 80 may be used to execute machine readable instructions. For example, the computer 80 may execute machine readable instructions to perform the methods shown in the block diagrams of FIGS. 2-8. In such examples, the machine-readable instructions comprise a program for execution by a processor such as the processor 81 shown in the example computer 80. The program may be embodied in software stored on a tangible computer readable medium such as a CD-ROM, a floppy disk, a hard drive, a digital versatile disk (DVD), a Blu-ray disk, or a memory associated with the processor 47, but the entire program and/or parts thereof could alternatively be executed by a device other than the processor 47 and/or embodied in firmware or dedicated hardware. Further, although the example programs are described with reference to systems and methods above, many other methods of implementing embodiments of the present disclosure may alternatively be used. For example, the order of execution of the blocks may be changed, and/or some of the blocks described may be changed, eliminated, or combined.

What is claimed is:

1. A system of synchronized computing devices connected via a common network and configured to operate one or more common computing tasks across the system, the system comprising:
a plurality of subcomponent computing devices, each of the subcomponent computing devices including, at least, a non-transitory, machine readable storage medium, each of the storage media of the plurality of subcomponent computing devices storing instructions associated with the one or more common computing tasks;
one or more processors, each of the one or more processors associated with one or more of the plurality of storage media, each of the one or more processors configured to execute instructions which, when executed, at least, output a plurality of events, occurring within the context of the one or more common computing tasks throughout the system;
at least one synchronization controller, operatively associated with one or more of the plurality of subcomponent computing devices, configured to receive the plurality of events from the one or more processors, to determine a continually updating state variable and a continually updating sum of error terms based on a symmetric function of the one or more events, provide the continually updating value of interest, subject to a time delay L, wherein L is a time period having a length substantially longer than an average time interval between two consecutive members of the plurality of events.

2. The system of claim 1, wherein the at least one synchronization controller is executed as instructions on each of the one or more processors, wherein each of the one or more processors are in continuous operative communication. (Note: FIG. 3 Example)

3. The system of claim 1, wherein the at least one synchronization controller is executed as instructions on one of the one or more processors. (Note: FIG. 4 Example)

4. The system of claim 1, wherein the at least one synchronization controller is executed as instructions on two or more of the one or more processors, wherein the two or more of the one or more processors are in continuous operative communication (Note: FIG. 5 Example)

5. The system of claim 1, wherein the at least one synchronization controller comprises one or more controller processing elements, each of the controller processing elements associated with one or more of the subcomponent computing devices and configured to perform functions of the synchronization controller. (Note: in this example, the synchronization controller is a hypothetical additional dedicated hardware controller, I am aware this is not done in your practice, but we are hypothetically protecting it)

6. The system of claim 1, wherein the at least one synchronization controller is a proportional-integral-derivative (PID) controller, configured to maintain a state variable U for each of the subcomponent computing devices, an events frequency factor T, and an integral term ΣΔ.

7. The system of claim 6, wherein the at least one synchronization controller synchronizes at a discrete series of points in time t, each of the plurality of subcomponent computing devices receives an input at t of:
Kₚ(R−Uₜ)+ΣΔₜ−K_{d}(Uₜ−Uₜ₋₁)
wherein Kₚ is a proportional gain,
K_{d} is a derivate gain,
Uₜ is the latest state variable value received from synchronization,
Uₜ₋₁ is the previous value received from the synchronization, and
R is a reference value.

8. The system of claim 7, wherein, when each event is recorded, each subcomponent computing device generates an error term:
$${Δ}_{t} = \frac{{K}_{i}}{{T}_{t}} ( R - {U}_{t} ) ,$$
wherein Kᵢ is a system integral gain,
Tₜ is a frequency factor, and
wherein the error term Δₜ is only sent to the at least one synchronization controller, does not update the local value of the integral term, and the subcomponent computing device continues to operate at the existing input level until the at least one synchronization controller sends back a consistent set of values for Uₜ, Tₜ, and ΣΔₜ.

9. The system of claim 8, wherein Tₜ is an external input representing the expected event count over L.

10. The system of claim 8, wherein Tₜ is calculated as an approximate count of past events over a certain window size using a trailing basis.

11. The system of claim 8, wherein Tₜ is calculated based on one of the current state variables.

12. A method for synchronizing a plurality of computing devices, each of the plurality of computing devices connected via a common network and configured to operate one or more common computing tasks amongst the plurality of computing devices, the one or more computing tasks including, at least, a plurality of events, the method comprising:
outputting, using a processor of at least one of the plurality of computing devices, the plurality of events, to at least one synchronization controller;
determining, using a processor associated with the at least one synchronization controller, a continually updating value of interest, based on a symmetric function of the plurality of events;
providing, using the processor associated with the at least one synchronization controller, the continually updating value of interest, subject to a time delay L, wherein L is a time period having a length substantially longer than an average time interval between two consecutive members of the plurality of events.

13. The method of claim 12, wherein the at least one synchronization controller includes, at least, a proportional-integral-derivative (PID) controller, configured to maintain a state variable U for each of the computing devices, an events frequency factor T, and an integral term ΣΔ.

14. The method of claim 13, wherein determining a continually updating value of interest includes synchronizing the plurality of computing devices at a discrete series of points in time t, each of the plurality of computing devices receives an input at t of:
Kₚ(R−Uₜ)+ΣΔₜ−K_{d}(Uₜ−Uₜ₋₁)
wherein Kₚ is a proportional gain,
K_{d} is a derivate gain,
Uₜ is the latest state variable value received from the synchronization,
Uₜ₋₁ is the previous value received from the synchronization, and
R is a reference value.

15. The method of claim 14, wherein when each event is recorded, the subcomponent generates an error term:
$${Δ}_{t} = \frac{{K}_{i}}{{T}_{t}} ( R - {U}_{t} ) ,$$
wherein Kᵢ is a system integral gain,
Tₜ is a frequency factor, and
wherein the error term Δₜ is only sent to the at least one synchronization controller, does not update the local value of the integral term, and the subcomponent computing device continues to operate at the existing input level until the at least one synchronization controller sends back a consistent set of values for Uₜ, Tₜ, and ΣΔₜ.

16. The method of claim 14, wherein Tₜ is an external input representing the expected event count over L.

17. A system for serving online advertisements to a subject to online advertising, the system comprising:
a plurality of synchronized computing devices connected via a common network and configured to operate one or more common advertising data operations across the system, each of the subcomponent computing devices including, at least, a non-transitory, machine readable storage medium, each of the storage media of the plurality of subcomponent computing devices storing instructions associated with the one or more common advertising data operations;
one or more processors, each of the one or more processors associated with one or more of the plurality of storage media, each of the one or more processors configured to execute instructions which, when executed, at least, output a plurality of events, occurring within the context of the one or more common advertising data operations throughout the system;
at least one synchronization controller configured to determine a continually updating value of interest, based on a symmetric function of the one or more events, provide the continually updating value of interest, subject to a time delay L, wherein L is a time period having a length substantially longer than an average time interval between two consecutive members of the plurality of events.

18. The system of claim 17, wherein the advertising data operation is a determination of a bid price for serving an advertisement to the subject to online advertising and the plurality of events is a plurality of changes in bid price for serving the advertisement to the subject to online advertising.

19. The system of claim 18, wherein the value of interest is a bid price to be submitted, via at least one of the one or more processors, to an advertising exchange.

20. The system of claim 19, wherein the one or more processors are further configured to submit the bid price, over the network via a network transceiver, to the advertising exchange, and, if the bid price is determined to be a win by the advertising exchange, serve an advertisement to the subject to online advertising.
